(19) United States
(12) Patent Application Publication
(10) Pub. No.: US 2011/0272539 A1
(43) Pub. Date: Nov. 10, 2011

(54) HANDGUN HOLSTER MOUNTING SYSTEM

(76) Inventor: GEORGE YAGI, Stockton, CA (US)

(21) Appl. No.: 13/103,058

(22) Filed: May 7, 2011

Related U.S. Application Data
(60) Provisional application No. 61/395,181, filed on May 10, 2010.

(51) Int. Cl. F41C 27/00; F16B 2/02; A44B 11/00; F16M 13/02; A44B 18/00

(52) U.S. Cl. 248/205.2; 248/220.21; 248/221.11

(57) ABSTRACT

A mounting system for securing a handgun holster to furniture, comprising a holster having a pistol receiving pouch and an attachment element, a mounting bracket having a horizontal plate portion connected to a vertical plate portion, the vertical plate portion having at least one opening, and a fastener for securing said attachment element to said mounting bracket at the opening. This handgun holster safely and reversibly secures a handgun to furniture to allow a user to store a handgun conveniently nearby for ready access without the risk of the holster falling off of the mounting system and unintentionally discharging the weapon.

### CROSS-REFERENCE TO RELATED APPLICATION

This application claims the benefit of U.S. Provisional Application No. 61/395,181, filed May 10, 2010.

### BACKGROUND OF THE INVENTION

1. Field of the Invention

The present invention generally relates to an improved apparatus for safely mounting a handgun holster in an easily accessible area on a bed or other furniture.

2. Description of Related Art

Increasing crime rates have caused many persons to be more concerned about their personal safety while in their own home, particularly at night. As a result, many of these people wish to have ready access to a handgun while in bed in case they are awakened by a burglar or other intruder entering their home. However, to be effective, the gun must be safely secured while at the same time readily accessible so the user can quickly place the gun in a useable firing position.

A number of devices have been previously developed as bedside holster mounts. A great majority of them, however, mount the pistol by means of a protruding metal plate or bracket. Examples of these are Keenan, 1984, U.S. Pat. No. 4,461,442; Jones, 1984, U.S. Pat. No. 4,466,148; Eddy, 1984, U.S. Pat. No. 4,483,501; Henson, 1985, U.S. Pat. No. 4,521,930; Hoffman, 1987, U.S. Pat. No. 4,691,396; and Krozal, 1992, U.S. Pat. No. 5,111,545.

The problem with these bedside mounting devices is that while they may support a holster and pistol, they do not firmly secure. them. This can be extremely dangerous as an occupant of the bed might knock the firearm from the mount during the night causing the weapon to be out of reach when an intruder enters or injury to pets or persons may occur if the gun accidentally discharges when it falls.

Keenan, Hoffman and Henson each attempted to invent a universal holster holder but each of these inventions failed to securely affix the handgun holster to the holster bracket.

For example, in Keenan the holster holder receives the belt loop of the handgun holster through a raised slit (“angled element”) in the holster bracket. However, Keenan fails to securely affix the handgun holster to the holster bracket. The holster mount in Keenan is unsafe as the gun holster may be easily knocked off of the bracket, for example, when the user tries to grab the handgun in the dark after being suddenly awoken by an intruder.

Likewise, the handgun bedside holster holder in Hoffman merely slides onto an angled, lipped support bar and the handgun holster is not secured 360 degrees rendering the holster mount unsecured and unsafe.

Both Hoffman and Keenan sought to solve the problem of positioning the handgun holster in an angled position for ready access by the user and failed to address the problem of fully affixing the handgun holster to the holster bracket to prevent accidently dislodging of the holster from the holster mount.

Henson, like Hoffman, uses a flanged support arm to slide the handgun holster onto the holster bracket. The handgun holster in Henson can also be easily be knocked off of the flanged support bar causing unintentional discharge of the firearm.

The holster mount in Krozal sought to better affix the handgun holster to the holster bracket but Krozal requires a specially designed holster.

The aforementioned holster mounting devices are either meant to hold the holster at a particular angle, to be used with a specially designed holster or they are structurally different from the present invention and are designed to solve a different type of problem. Therefore, it is an object of the present invention to provide an improved apparatus for a handgun mounting device that can safely, securely and reversibly secure a handgun to a mounting system.

A further object of the present invention is to provide an improved handgun mounting system that can be secured between two mattresses or other furniture selected by the user for easy access against intruders.

A further object of the present invention is to provide an improved handgun mounting system that can attach a universal handgun holster thereby not requiring any specialized holster device.

A further object of the present invention is to provide an improved handgun mounting system that prevents the handgun holster from unintentionally falling off of the holster mounting system to prevent unintended injury to the user, other persons or pets.

There exists a need for a universal handgun holster mounting system that provides easy access to a pistol while at the same time ensuring that the firearm is securely, yet reversibly, affixed to the system to avoid accidental discharge of the pistol and likely injury to the user or other unintended victims.

### SUMMARY OF THE INVENTION

These and other features and advantages of this invention are described in, or are apparent from, the following detailed description of various exemplary embodiments of the apparatus according to this invention.

The present invention relates to an improved apparatus for a mounting system that provides easy access to a pistol while at the same time ensuring that the firearm is securely affixed to the system to avoid accidental discharge of the pistol and likely injury to the user, other persons or pets. The apparatus solves the inherent problems of handgun holster mounts that fail to securely and reversibly affix the handgun holster to a mounting device and increases the safety in the art of handgun mounting systems.

The mounting system for securing a handgun holster to furniture comprises a holster, a pistol receiving pouch and an attachment element, a mounting bracket having a horizontal plate portion connected to a vertical plate portion, at least one opening in the vertical plate portion, and a fastener for securing the attachment element to the mounting bracket at the opening in the vertical plate portion. The mounting system may be used in conjunction with any furniture that can receive and secure the horizontal plate portion of the invention.

In one embodiment, of the present invention the mounting system is secured between the mattress and box spring of a bed.

In another embodiment of the present invention, the fastener securing the attachment element of the holster to the mounting bracket is a strap having a hook and loop fastener attached at the ends. The strap can be passed through the loop or clip of a universal holster and firmly secured to the mounting bracket for easy access and removal.

### BRIEF DESCRIPTION OF THE DRAWINGS

A more complete understanding of the present invention and the attendant features and advantages thereof may be had by reference to the following detailed description when considered in conjunction with the accompanying drawings wherein:

FIG. 1 is a front view of a handgun gun holster mounting system.

FIG. 2 is a side view of a handgun gun holster mounting system.

FIG. 3 is a front view of a belt having a hook portion of a hook and loop fastener at one end.

FIG. 4 is a back view of a belt having a loop portion of a hook and loop fastener at one end.

FIG. 5 is a front view of a handgun gun holster mounting system.

FIG. 6 is a top view of a handgun holster mounting system.

### FIGURES—REFERENCE NUMBERS

10 . . . Handgun holster mounting system
12 . . . Vertical plate portion
14 . . . First opening
16 . . . Second opening
18 . . . First rivet
20 . . . Second rivet
22 . . . Horizontal plate portion
24 . . . Belt
26 . . . Hook portion of a hook and loop fastener
28 . . . Loop portion of a hook and loop fastener
30 . . . Universal handgun holster
32 . . . Loop

### DETAILED DESCRIPTION OF THE INVENTION

Most handgun holsters are universally manufactured to include a belt loop or clip to attach the holster to the belt of a person for portable storage and access. The present invention uses these universal handgun holsters to affix to the holster to the holster mounting system.

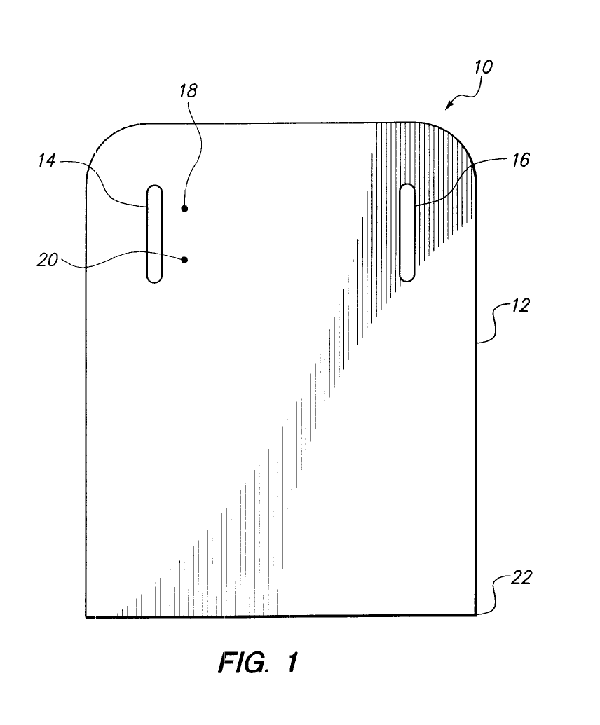

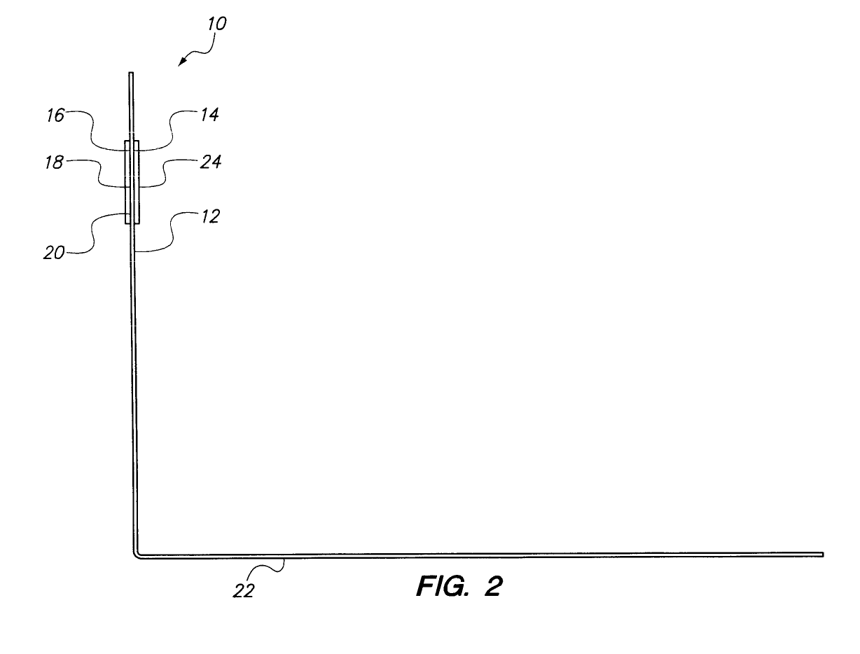

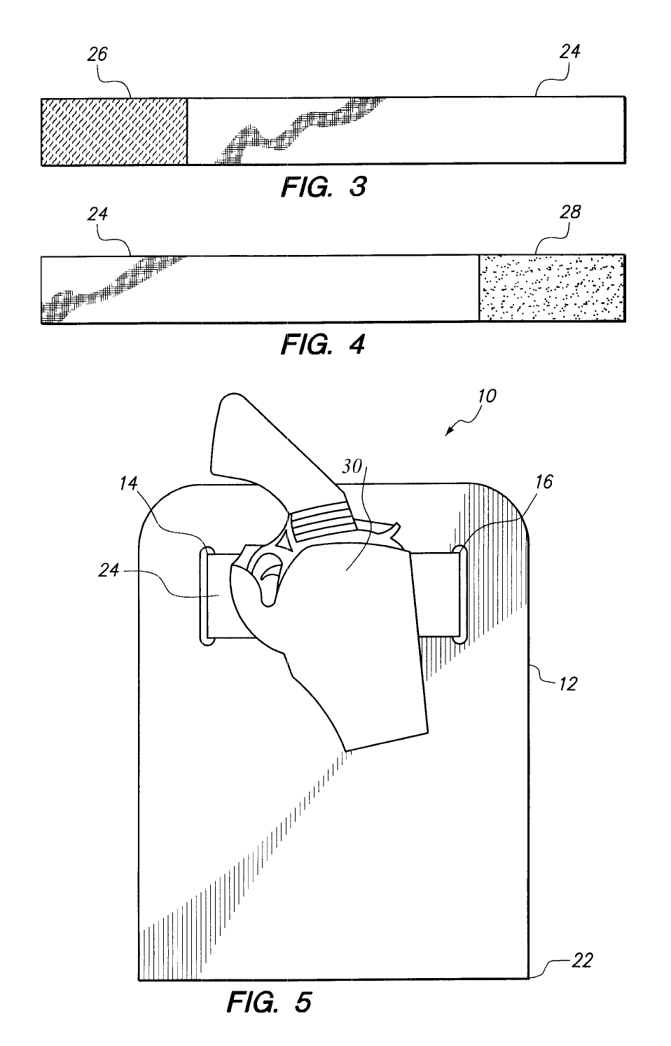

The novel features of the present invention will become apparent from the following description of the preferred embodiment, and as illustrated in FIGS. 1 through 6. The present invention is a handgun holster mounting system 10.

Referring to FIGS. 1 through 6, the handgun holster mounting system 10 comprises a horizontal plate portion 22 and a vertical plate portion 12. The vertical plate portion 12 consists of two openings 14, 16 and two small rivets 18, 20 to firmly attach a belt 24 to the holster mounting system 10. A belt 24, fitted with a hook and loop fastener 26, 28, is passed through the first opening 14, fastened at the back of the vertical plate portion 12 with rivets at the holes provided at 18, 20, and then passed through a second opening 16.

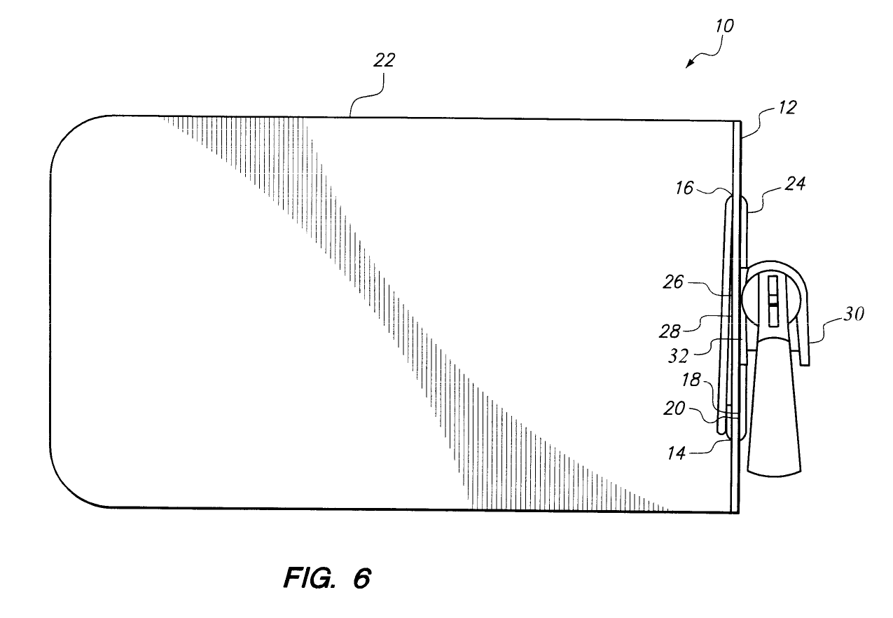

Referring to FIGS. 5 and 6, the handgun holster mounting system 10 secures a universal gun holster 30 by passing a belt 24, through the first opening 14, through the belt loop 32 of the gun holster 30 bringing the belt back through the second opening 16 and securing it with a hook and loop fastener 26, 28. Once the holster 30 is secured in handgun holster mounting system 10, the horizontal plate portion 22 can be slid in between the mattress and box spring of a bed or otherwise secured by a piece of furniture.

In one example of a preferred embodiment, the handgun holster mounting system 10 is comprised of a vertical plate portion 12 about 10″ long and 8″ wide and a horizontal plate portion 22 about 15″ long and 8″ wide. The vertical plate portion 12 comprises two openings 14, 16, about 2″ long and 1/4″ wide, located about 1″ from the top of the holster mounting system 10, and about 1/2″ from each side with about 5″ in between them. Both the vertical plate portion 12 and horizontal plate 22 have rounded corners about 1″ by 1″. The belt 24 about 15″ long and 2″ wide is accompanied by respective strips of a hook and loop fastener 26, 28 measuring about 4″ long and 2″ wide.

The construction details of the invention as shown in FIGS. 1 through 6 are that the handgun holster mounting system 10 may be made of metal or of any other sufficiently rigid and strong material such as high strength plastic, fiberglass, and the like. The belt 24 may be made out of nylon, leather, fabric, rubber or any other sufficiently strong material. While rivets 18, 20 can be used to fasten the belt 24 to the vertical plate portion 12, other methods involving some sort of adhesive or other fastener might also be used.

The handgun holster mounting system of the present invention can be constructed of an inexpensive, light weight material such as plastic or the like, although materials such as metal and wood are also suitable.

While the present invention is described with reference to the illustrations for specific applications, it should be understood that the invention is not limited to those applications. Those skilled in the art with access to invention described herein will recognize additional modifications, applications, and embodiments within the scope thereof and additional fields in which the invention would be of significant utility.

The features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

While a specific apparatus has been disclosed in the preceding description, it should be understood that these specifics have been given for the purpose of disclosing the principles of the present invention and that many variations thereof will become apparent to those who are versed in the art. The invention should therefore not be limited by the above described embodiment, method, and examples, but by all embodiments and methods within the scope and spirit of the invention as determined by the appended claims.

Any element in a claim that does not explicitly state “means for” performing a specific function, or “step for” performing a specific function, is not to be interpreted as a “means” or “step” clause as specified in 35 U.S.C. §112, paragraph 6. In particular, the use of “step of” in the claims, if used herein, is not intended to invoke the provisions of 35 U.S.C. §112, paragraph 6.

What is claimed is:

1. A mounting system for securing a holster to furniture, said holster comprising a pistol receiving pouch and an attachment element, wherein said mounting system comprises a mounting bracket having a horizontal plate portion connected to a vertical plate portion, said vertical plate portion having at least one opening formed therein, and a fastener for securing said attachment element to said mounting bracket at said opening.

2. The mounting system of claim 1, wherein said holster is reversibly affixed to said mounting system.

3. The mounting system of claim 1, wherein said furniture is a bed.

4. The mounting system of claim 1, wherein said furniture is a sofa.

5. The mounting system of claim 1, wherein said furniture is a chair.

6. The mounting system of claim 3, wherein said bed comprises at least two mattresses wherein said horizontal plate portion is inserted between said mattresses.

7. The mounting system of claim 3, wherein said bed comprises at least one mattress and a solid bed frame wherein said horizontal plate portion is inserted between said mattress and said solid bed frame.

8. The mounting system of either claims 4 or 5, wherein said horizontal plate portion is inserted between a solid support structure and at least one cushion.

9. The mounting system of claim 1, wherein said furniture is a shelving unit.

10. The mounting system of claim 1, wherein said furniture is a desk.

11. The mounting system of either claims 9 or 10, wherein said horizontal plate portion is inserted between two solid support structures.

12. The mounting system of claim 1, wherein said attachment element is a loop.

13. The mounting system of claim 1, wherein said attachment element is a clip.

14. The mounting system of claim 1, wherein said attachment element is at least one snap.

15. The mounting system of claim 1, wherein said mounting bracket comprises metal.

16. The mounting system of claim 1, wherein said mounting bracket comprises plastic.

17. The mounting system of claim 1, wherein said mounting bracket comprises wood.

18. The mounting system of claim 1, wherein said horizontal plate portion and said vertical plate form an L-shape.

19. The mounting system of claim 1, wherein said vertical plate portion has at least two openings.

20. The mounting system of either claim 1 or claim 19, wherein said fastener is a strap.

21. The mounting system of claim 20, wherein said strap comprises fabric.

22. The mounting system of claim 20, wherein said strap comprises leather.

23. The mounting system of claim 20, wherein said strap comprises metal.

24. The mounting system of claim 20, wherein said strap comprises rubber.

25. The mounting system of claim 20, wherein said strap comprises plastic.

26. The mounting system of claim 20, wherein said strap is secured to said mounting bracket with at least one rivet.

27. The mounting system of claim 20, wherein said strap is received through said openings of said mounting bracket and said attachment element.

28. The mounting system of claim 27, wherein said strap further comprises a hook and loop fastener.

29. The mounting system of claim 27, wherein said strap further comprises a buckle.

30. The mounting system of claim 27, wherein said strap further comprises a clasp.
